(19) United States
(12) Patent Application Publication
(10) Pub. No.: US 2012/0256424 A1
(43) Pub. Date: Oct. 11, 2012

(54) CONTROLLED, DIFFUSED, AND AUGMENTED WIND ENERGY GENERATION APPARATUS AND SYSTEM

(75) Inventor: Ed Marin, Plattsburgh, NY (US)

(73) Assignee: AWR ENERGY, INC., Rochester, NY (US)

(21) Appl. No.: 13/387,731

(22) PCT Filed: Dec. 28, 2010
(86) PCT No.: PCT/US10/62272

§ 371 Date: Jan. 28, 2012

Related U.S. Application Data
(60) Provisional application No. 61/290,396, filed on Dec. 28, 2009.

(51) Int. Cl. F03D 9/00; F03D 11/00

(52) U.S. Cl. 290/55; 415/182.1

(57) ABSTRACT

An apparatus and system for increasing power output for wind energy generation through a diffusing mechanism. An apparatus and system for mixing the wake and external flow, thereby permitting increasing mass-flux for wind energy generation. An apparatus to control and energize the boundary layer associated with wind energy generation by the use of an intake, bypass, and diffuser mechanism. A distributed load support provided by a wind energy generation apparatus and system. An apparatus for augmenting a wind energy generation system by achieving an increased energy extraction per unit of primary mass-flow.

### CROSS-REFERENCE TO RELATED APPLICATION

The present application claims priority to U.S. Provisional Application Ser. No. 61/290,396, filed on Dec. 28, 2009, which is hereby incorporated by reference in its entirety.

### FIELD

This disclosure relates in general to the field of energy production and more particularly to wind turbines.

### BACKGROUND OF THE INVENTION

Substantial literature exists, describing the use of wind turbines to transfer the kinetic energy of the wind into electrical energy via an electrical generator. The aerodynamics of a wind turbine system influence performance and the cost of energy.

Most conventional wind energy generation systems may be of three and two bladed systems with airfoils rotating freely and un-shrouded. Some shrouded systems may have been designed to reduce blade tip losses and improve aerodynamic efficiency by use of a shroud surrounding the aerodynamic swept area. Additionally, wind energy generation systems employing diffuser augmentation, in which the shroud annulus transitions into a diffuser and induces a pressure drop, may create a vacuum that may improve the aerodynamic system and the electrical generator efficiency.

Some wind energy generation systems may have also incorporated a bypass method wherein massflow from the outer blade perimeter is used to enhance the diffuser. The focus of such systems may be on the exit area ratio defined as the ratio the aft most diffuser area to the foremost diffuser area.

Many have tried to become independent from the public power grid, but to accomplish this, one has to create a multi level power platform that has the flexibility of using many natural resources, since some like the wind are not consistent and are unreliable. The conventional solution requires multiple controllers, allows no integration, is not effective, and is repetitive and costly.

Further, conventional wind energy generation systems are not accessible in times of natural crisis where the power grid has been damaged or has failed. It is also difficult to access in remote areas on the world.

The above-mentioned approaches have shortcomings. More particularly, other wind energy generations systems address the wind flow in a two dimensional manner with little regard to the three dimensional vortex flow imparted by the rotating bladed system.

The above-mentioned approaches may be impractical build designs that have been economically impractical for commercialization of wind energy generation systems.

Heretofore unrecognized problems in the background of the invention. A need exists, therefore, for an improved wind energy generation systems without shortcomings.

### SUMMARY

The following disclosure presents concepts for improving power output for wind energy generation through a diffusing mechanism. The disclosed subject matter significantly improves upon prior art aimed at augmenting wind energy generation. It is an object of the present disclosure to permit an increased mass-flux and pressure gradients for wind energy generation. Further, it is an object of the present disclosure to control and energize the boundary layer associated with wind energy generation by the use of an intake, bypass, and diffuser mechanism.

One aspect of the disclosed subject matter is a distributed load support provided by a wind energy generation apparatus and system.

The present disclosure teaches an apparatus for system by achieving an increased energy extraction per unit of primary mass-flow.

Yet another aspect of the disclosed subject matter is diffused and augmented wind energy generation that focuses on the three dimensional aerodynamics.

Another aspect of the disclosed subject matter is to provide a wind energy generation system that optimizes performance based on Reynolds number, turbulence, and boundary layer parameters.

Yet another aspect of the disclosed subject matter is a diffuser included angle gradient that promotes attached flow for maximum efficiency and boundary layer control.

Another aspect of the disclosed subject matter is a self-aligning system.

Yet another aspect of the disclosed subject matter is an apparatus and system for measuring the wind direction.

Another aspect of the disclosed subject matter is an apparatus and system for aligning the wind energy generation system to optimally face into the wind.

Yet another aspect of the disclosed subject matter is to provide a light weight material for the manufacture of the presently disclosed wind energy generation system.

Another aspect of the disclosed subject matter is a high-speed, low-cost manufacturing method for the design and production of the presently disclosed wind energy generation system.

Yet another aspect of the disclosed subject matter is the control of the disclosed wind energy generation system to be stirred in the wind.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of any claims filed later.

### BRIEF DESCRIPTIONS OF THE DRAWINGS

The novel features believed characteristic of the presently disclosed subject matter will be set forth in any claims that are filed later. The presently disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 shows an exemplary diffuser augmented wind energy generation system.

FIG. 2 displays a view of open petals that make up the diffuser shape of an alternative exemplary diffuser augmented wind energy generation system.

FIG. 3 portrays an embodiment of the diffuser augmented wind energy generation system with straight bypasses.

FIG. 4A illustrates the back view of an alternate embodiment of the diffuser augmented wind energy generation system with circumferential bypasses.

FIG. 4B illustrates the front view of an alternate embodiment of the diffuser augmented wind energy generation system with circumferential bypasses.

FIGS. 5A and 5B show the active boundary layer controls as located on the blades.

FIGS. 6A and 6B show the diffused inner shroud and diffuser bypass exit.

FIG. 7 illustrates the exit flow as it meets the freestream flow outside of the diffuser.

FIG. 8A displays support structure providing only support for an exemplary diffuser augmented wind energy generation system.

FIG. 8B displays support structure providing both support and flow modification for an alternative exemplary diffuser augmented wind energy generation system.

FIG. 9A illustrates vanes for guiding diffuser flow and reducing cross flow.

FIG. 9B illustrates channels for guiding airflow entry and reducing cross flow.

FIG. 10A shows an exemplary diffuser augmented wind energy generation system with an attached anemometer.

FIG. 10B shows a close-up perspective of an exemplary wind vane.

FIG. 11 illustrates high surface area lifting airfoils as taught in this present disclosure.

FIG. 12 shows an exemplary blade pitched and tapered as taight in this present disclosure.

FIG. 13 illustrates an operational flow cross section of airflow on a blade.

FIG. 14 illustrates an exemplary nose cone spinner and tail cone.

FIG. 15 illustrates sectioned cells of the diffuser.

### DETAILED DESCRIPTION OF THE SPECIFIC EMBODIMENTS

Although described with particular reference to wind energy generation, those with skill in the arts will recognize that the disclosed embodiments have relevance to a wide variety of areas in addition to those specific examples described below.

All references, including publications, patent applications, and patents, cited herein are hereby incorporated by reference to the same extent as if each reference were individually and specifically indicated to be incorporated by reference and were set forth in its entirety herein.

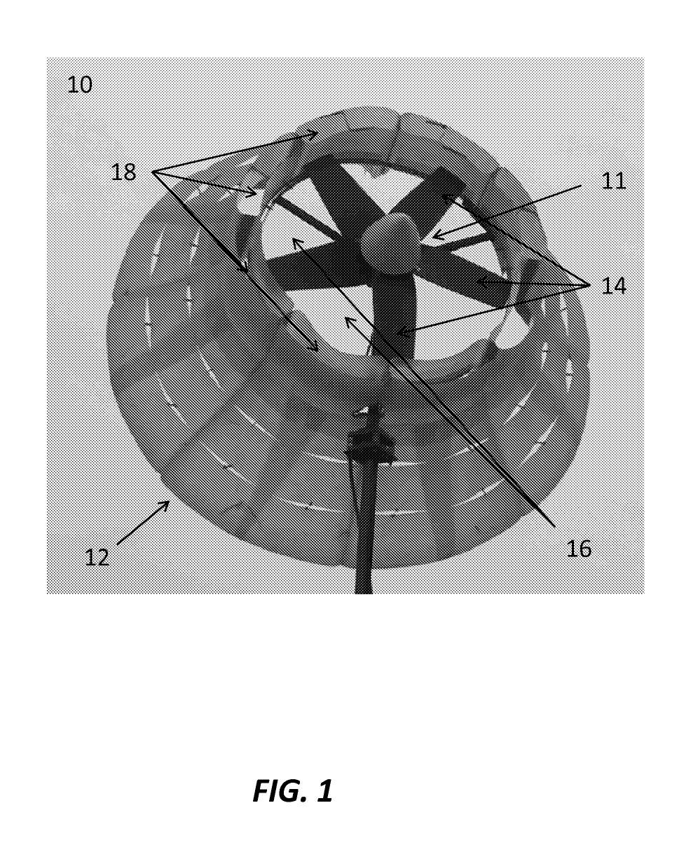

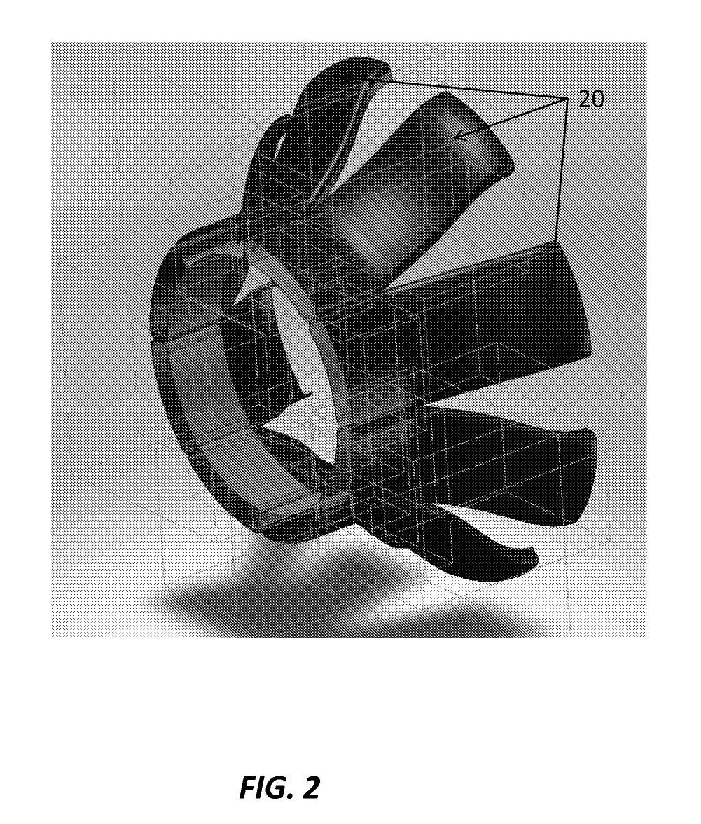

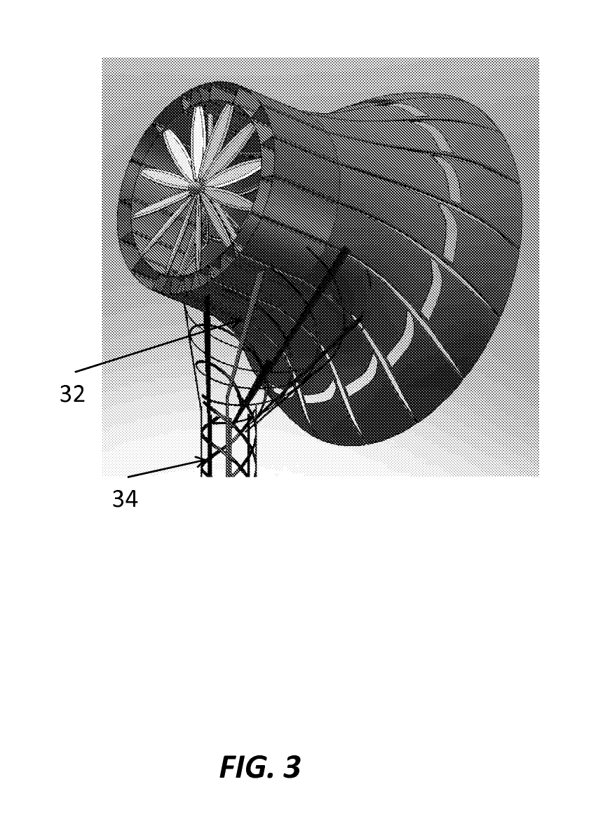

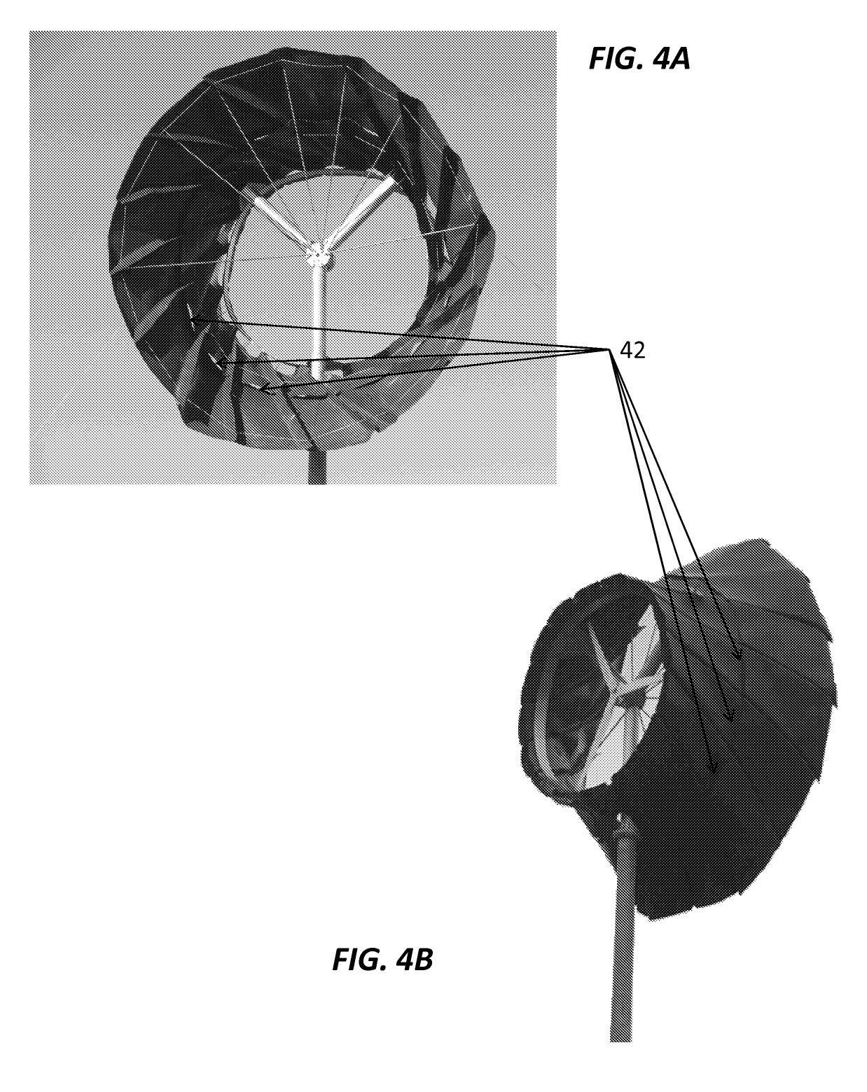

FIG. 1 shows an exemplary diffuser augmented wind energy generation system 10. A mass flow gap subsequently mixes with the main flow in the center section of the exemplary diffuser augmented wind energy generation system 10. Diffuser 12 contains a large diameter inlet 16 and a mass flow gap, herein called bypass 18. Further, inlet 16 may contain a generator 11. Subcomponents of generator 11 may include a plurality of rotor blades 14, which are rotated, thereby generating useful work, which may be transformed to electrical energy. Rotor blades 14 with a larger surface area will cause a rotor to rotate faster in light winds when compared to a rotor blade 14 with a smaller surface area. In contrast, rotor blades 14 with smaller surface area will cause a rotor to rotate faster in heavy winds when compared to a blade with a larger surface area. Diffuser 12 may be made of solid petals 20, as shown in FIG. 2, or may be made of flexible membranes and structures. Bypass 18 around the perimeter may be flush with the front plane and located at the front face of the diffuser 12 to avoid separation of air flow and optimize wind energy generation despite changes in wind direction and/or wind magnitude. Other concepts, with bypasses at the back, minimize or eliminate wind flow from entering. Wind flow coming in at an angle will block or shadow wind flow coming in from the opposite side. The present disclosure's allowing of wind to enter inlets regardless of angle of wind flow allows improved management of turbulent wind flow. Even if turbulent flow is temporary, it can cause tremendous unsteady turbulence in the diffuser itself, reducing power generation. Further, bypass 18 could be either straight as illustrated in FIG. 3 or rifled as illustrated in FIGS. 4A and 4B.

Further, the exemplary diffuser augmented wind energy generation system 10 may contain a composite tower system with a cradle 32 and truss 34 to distribute the load forces. Cradle 32 may spread the load of the system weight. Truss 34, which may be, but is not limited to being, of composite material may manage internal forces. FIG. 3 illustrates the supporting truss 34 in an exemplary diffuser augmented wind energy generation system. Truss 34 is connected to cradle 32. The combined structure of truss 34 and cradle 32 provides distributed load support.

Electrical bearing, a component of the generator 11, is formed by combining a slip ring and friction bearing. Electrical conductors and instrumentation channels may be molded into the friction bearing. Diffuser wind vane forces allow for the use of the friction bearing made out of materials such as oil impregnated, metals such as brass or steel, and various composites, instead of expensive roller bearings. The friction bearing's lack of moving parts increases its reliability and reduces costs of manufacturing. Additionally, the bearings within generator 11 may be made of ceramics such as Silicon Nitride to improve generator quality due to its corrosion resistance, higher hardness, low thermal expansion, and tighter tolerance.

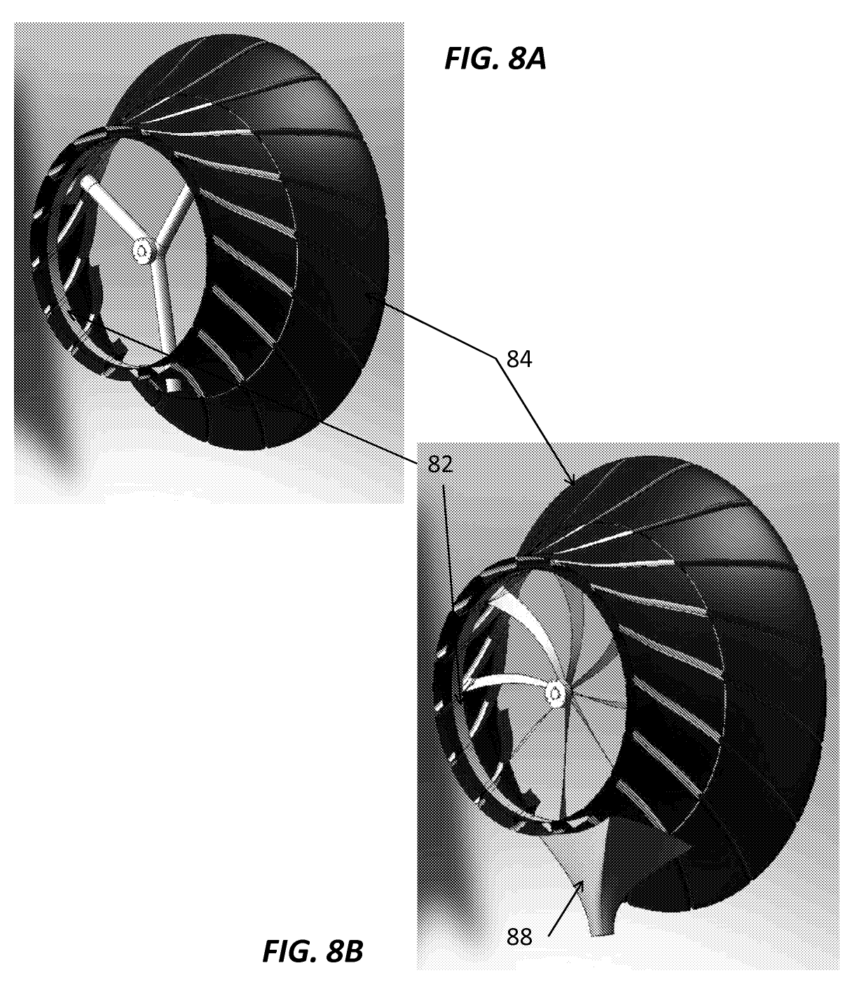

FIGS. 8A and 8B show the distributed load structure of diffuser augmented wind energy generation system 10. The structure in this embodiment transfers load from generator 11 to spokes 80, which in turn transfers load to center ring 82, which in turn transfers load to shroud 84, which in turn transfers load to bud 86, which in turn transfers load to tower 88. This enables a uniform load on the entire structure and reduces drag.

Further support structure includes a twisting structure that holds the generator 11 and holds the center ring 82 together. This internal center ring 82 is stiffened and transfers load from the shroud to the rest of the structure. Additionally, the stiffness allows use of smaller blade tip clearances and reduces blade tip loss. Rather than incorporating a Y-shaped design to be used for pure load transfer, the present disclosure teaches the use of twisters that hold the generator 11 up, but also help wind flow turn and increases flow dynamics. Another method of providing support includes the use of light weight shrouds to reduce overall structure load.

Further, the diffuser 12 of exemplary diffuser augmented wind energy generation system 10 may be self-adjusting to adjust for stress load, air pressure, or power optimization. The diffuser shape may be self-adjusting for turbine efficiency or for structural stress reduction. If the petals 20 of diffuser 12 are stiff, hinging the petals 20 would allow them to move for adjustment. If the petals 20 are flexible, they could adjust by increasing external wind force or varying internal pressure.

The present disclosure further teaches an energy storage mechanism within the diffuser augmented wind energy generation system 10. An exemplary embodiment involves a turbine in a stand alone system where a battery storage system has been filled to capacity. The diffuser augmented wind energy generation system 10 may be used to pressurize a cavity, such as a bladder with air that may be released later. The cavity may be a plenum located within tower 88. The higher potential energy capture by pumping water to an altitude or pressurizing air within a cavity may be released at a later time to generate electricity when the diffuser augmented wind energy generation system 10 cannot produce energy due to reduced natural resource. The energy storage mechanism may also be used as a gust dampening system.

The aerodynamic principles employed in the present disclosure may permit a reduction in the amount of work required by the exemplary diffuser augmented wind energy generation system 10, since the air flow may align itself with both the rotor blade 14 and diffuser 12 as it enters and leaves the system of the present disclosed subject matter. The present subject matter may implement a rifling approach, which may allow for more efficient work to be imparted into the generator 11. A diffuser 12 with rifling shows wind flow separation starting later and leads to faster internal wind flow as compared with those without rifling. The level of wind flow experienced at the blade plane with rifled diffuser 12 shapes may be double that of those without rifling. Hence, the subject matter of the present disclosure may provide more aerodynamic energy to be converted into electrical energy.

Rifling has both functional and ornamental aspects to the exemplary diffuser augmented wind energy generation system 10. Individual rifling and vertical stiffeners on diffuser panels forces wind flow to turn. By incorporating this wind turn with the turning wind flow through the blades, we can avoid an abrupt change from turning wind of the blades to a straight flow transition out the back of the diffuser. A more gradual transition from a twisting and turning vortex into direct flow reduces energy loss. Further diffuser 12 does not incorporate bypass 18 after the front entry plane of the wind energy generation system; instead the placement of bypass in the present disclosure promotes a more efficient system.

The air from bypass 18 subsequently mixes with the main flow in the center of the section of diffuser 12. The air flow from an area of greater volume into a smaller volume passageway, such as bypass 18, is designed to increase the velocity of the air flow and increase the efficiency of the exemplary diffuser augmented wind energy generation system 10. The creation of two separate flows via the separation caused by bypass 18 of air thereby creates a vacuum force that increases electricity generation.

The present disclosure further teaches the application of boundary layer control mechanisms for improved system efficiency.

An exemplary mechanism for boundary layer control may achieved by the positioning and location of openings or slots to prevent flow separation. would be the application of either radial slots 32, as illustrated in FIG. 3, or circumferential slots 42, as illustrated in FIGS. 4A and 4B, between panel cells to promote the flow of wind through the diffuser 12.

These slots, placed to reduce boundary layer separation along the internal shroud, are used to energize wind flow by managing directionality of wind flow and allowing the wind to move in and through the diffuser 12 instead of separating. Diffuser 12 may have multiple circumferential slots 42 and radial slots 32 at multiple circumferential and radial locations. The slots may be made by overlapping, cutting or molding petals 20.

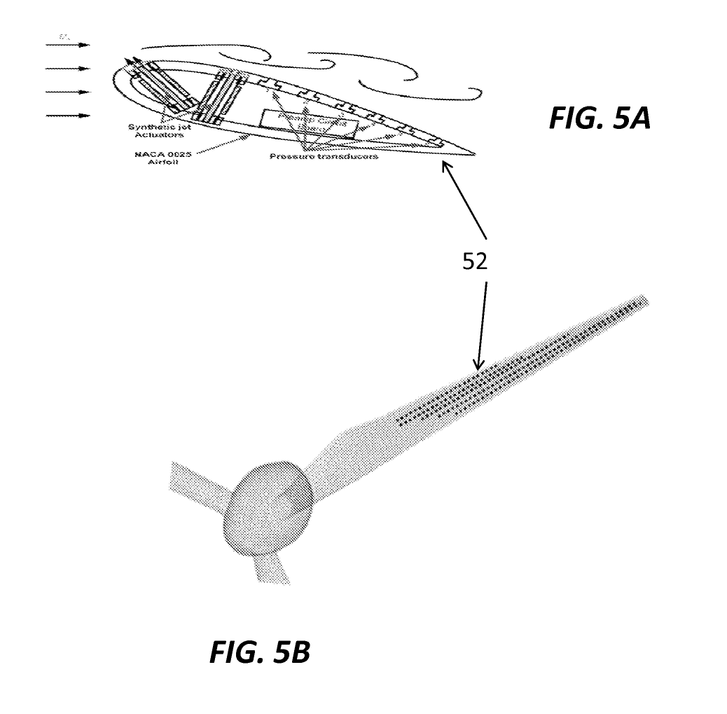

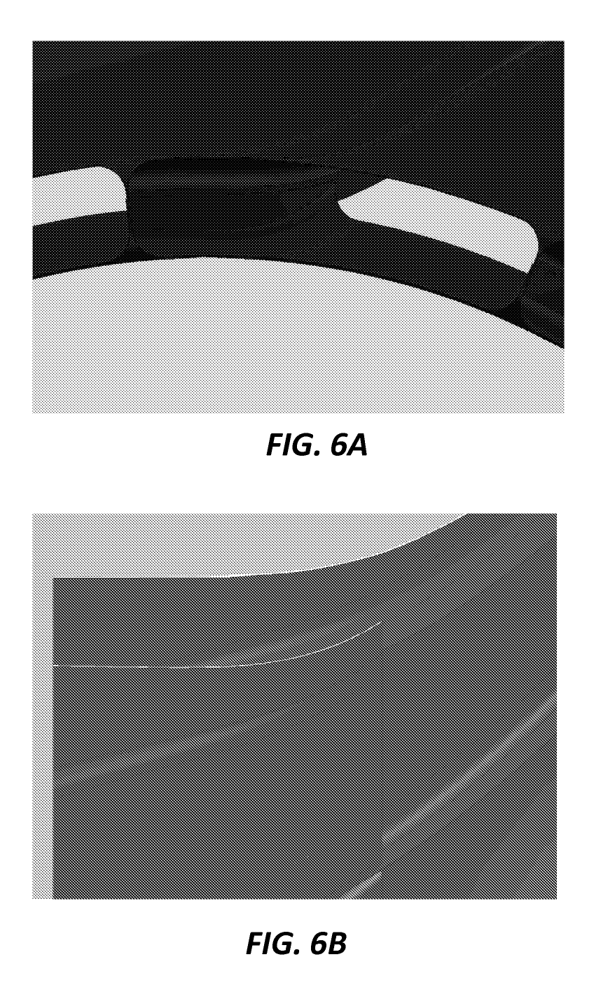

The active control technology of FIGS. 5A and 5B includes shape control actuators installed on a twisted-coupled blade 52, made possible through the use of composite and active materials. This has the potential for improvements in cost, reliability, and performance of large horizontal-axis wind turbines. The twisted-coupled blade 52 manufactured by advanced composite materials may enhance the aerodynamic performance and fatigue life. Aeroelastic tailoring is a cost-effective, passive means to shape the power curve and reduce loads. Additionally, low power flow control actuators may be used for unsteady loading alleviation and enhancing the aerodynamic performance. The shape of the blades or shroud itself may be changed, either by having a softer surface or changing shape through piezoelectric, temperature, or air flow means. Entering or exiting air can create suction that force changes in material shape. Additionally, these material shape changes can act as dampening for air gusting.

Additionally, the present disclosure teaches the use of a porous shroud that may be made of a mesh material or open composite to allow air to move through the diffuser 12 to self regulate pressure gradients and boundary layer separations. Additionally, diffused inner shrouds may be used at the diffuser bypass exit to help transition wind flow. Lastly, the present disclosure also teaches the use of virtual convergers created by separation vortexes developing. With the edge vortex developing from front to back of diffuser, as it grows it constricts the flow and accelerates center wind flow.

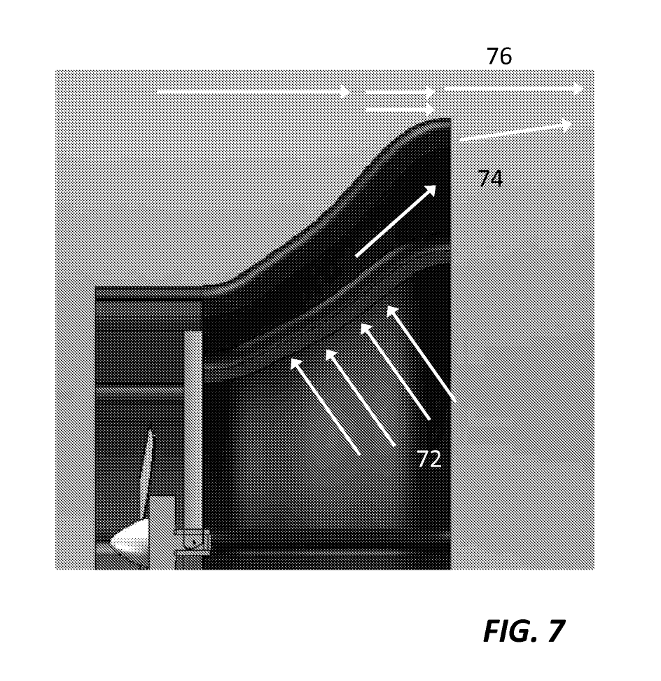

The present disclosures teaches an apparatus and system for controlling, diffusing, and augmenting wind such that air flow enters the wind energy generation system and transitions into an angle of attack pertinent to the rotor blades 14 and leaves at a similar angle and direction. FIG. 7 shows diffuser 12 with a controlled increase in diffuser angle 72. The diffuser 12 is positioned downstream of the rotor blades in order to reduce vorticity and curl of the vorticity. The controlled increase in diffuser angle diffuser angle 72 provides a controlled increase in the gradient of the flow angle transition. Further, the diffuser angle 72 is gradually increased in order to promote a smooth transition of flow and reduce drag imposed on the plurality of rotor blades 20, and prevent flow separation.

FIG. 7 shows the exit flow 74 as it meets the freestream flow 76 outside of diffuser 12. The exit angle may be parallel with the freestream flow 76 at point where the diffuser 12 interfaces with exit flow 74. By making exit flow through the back as parallel as possible to freestream flow, the present disclosure enables air flow internally match up with external to reduce turbulence, create better air pressure vacuums, and minimize power loss.

In exemplary diffuser augmented wind energy generation system 10, the use of an exit angle that is parallel with the freestream flow 76 may equate to an increase in the thrust coefficient, which may be higher than unity, and may increase the energy extraction per unit of primary mass-flow in comparison to a non-parallel exit angle.

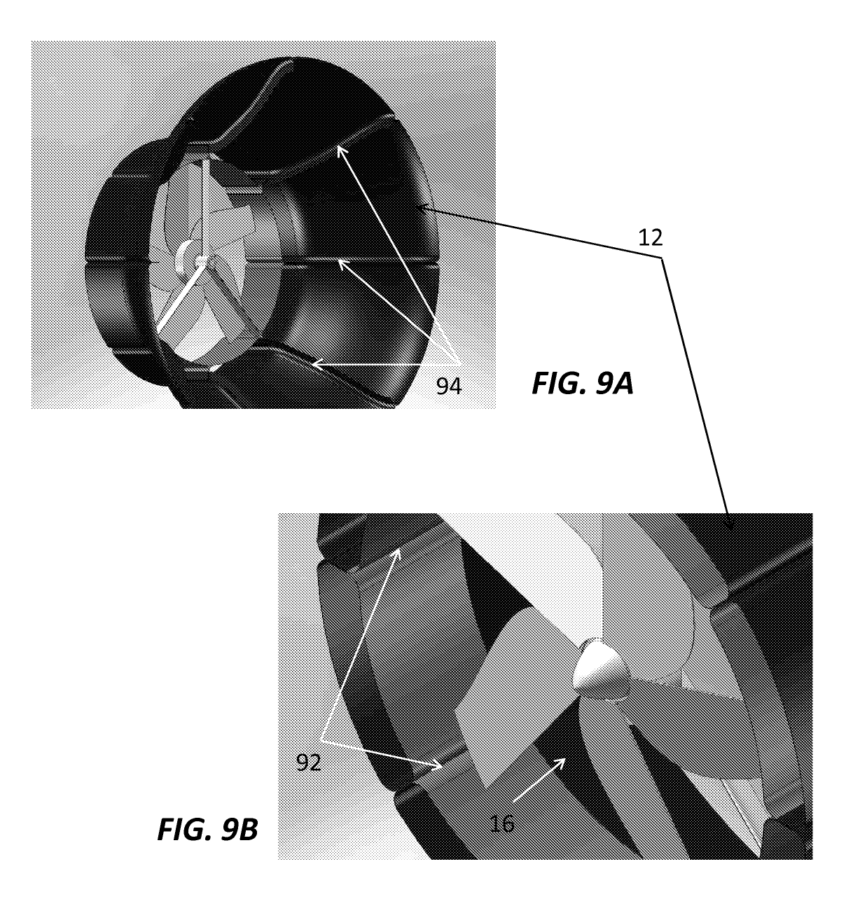

FIG. 9A is a detailed perspective view of diffuser 12 from the viewpoint of the exit. A plurality of vane guides 94 for reducing cross flow are providing, thereby smoothing out the flow non-uniformities and reducing turbulence. There are also straight channels along the entire inner, front section that is also made with rifling. This not only helps with air flow stay in the direction of those channels, but with rifling also helps with wind flow turning before wind reaches the diffuser. The vanes act as structural support that increases moment of inertia which drives stiffness but also forces the flow to start to turn as well.

FIG. 9B displays a close-up view of inlet 16 of an exemplary diffuser augmented wind energy generation system 10. Inlet 16 contains exemplary channel guides 92 for reducing cross flow. A reduction of cross flow smoothes out non-uniformities and reduces turbulence. Further, a plurality of airflow channels that are created by designing the shroud in radial sections with fillets are shown as bypass 18.

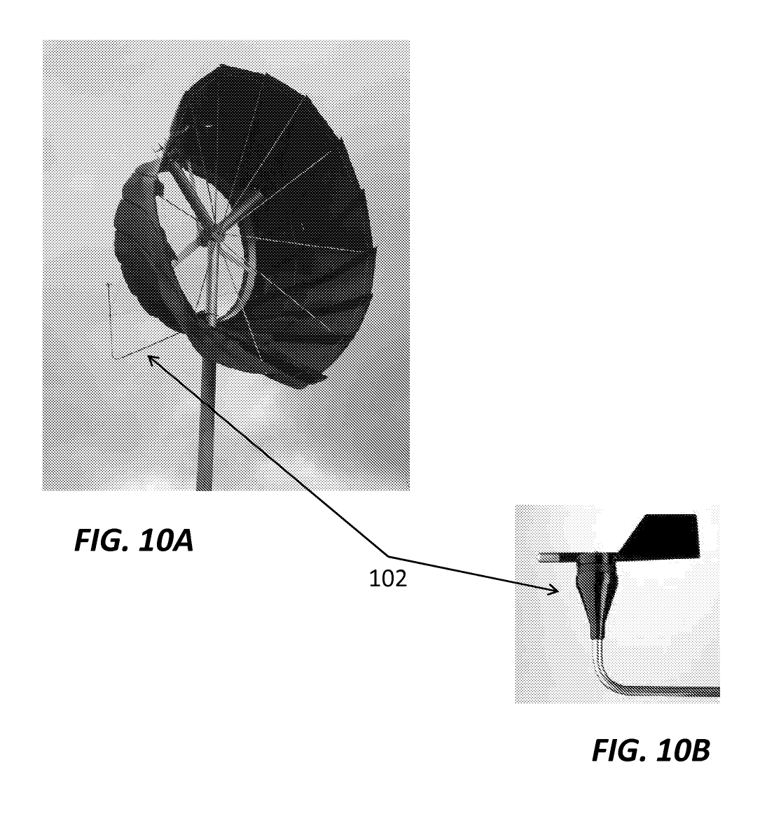

Further, the exemplary diffuser augmented wind energy generation system 10 may be a self-aligning system, as illustrated in FIGS. 10A and 10B. More particularly, the present disclosure teaches an apparatus and system for measuring wind direction and for aligning the wind energy generation system to optimally face into the wind. This passive self-orientation may be accomplished through the use of a self positioning anemometer 102 that is built in and always orients into the wind. Further, this anemometer 102 is accurate from all directions.

Further, the aerodynamics may be influenced using controlled surface roughness and texture as taught in the present disclosure. Dimples, or other indentations in the surface, may be used to cause localized suction created by vacuums when wind flows over the dimples. Bumps may be used to cause turbulence behind it when wind flows over the bump in a smooth transition. Alternatively, scales, with a finer point transition at the tip than bumps, may be used to reduce drag and increase wind flow through. Patterning, such as macro-, micro- or nano-sizing to mimic the surface of animals, may also be used to influence wind flow. Any of these can be placed in various patterns inside the diffuser to increase turbine efficiency.

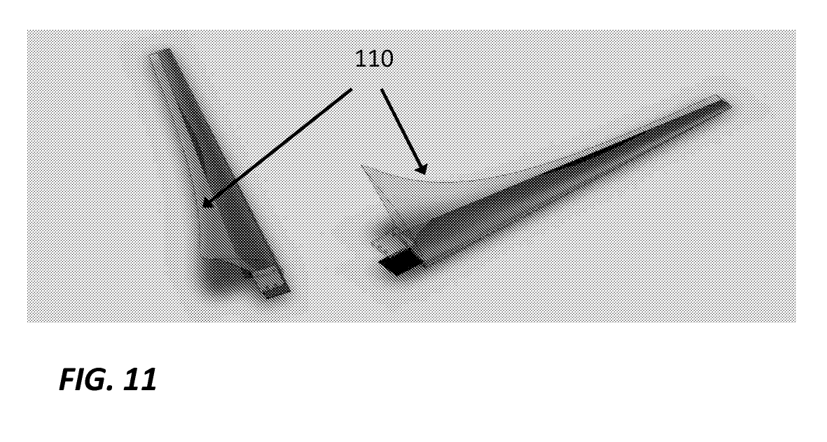

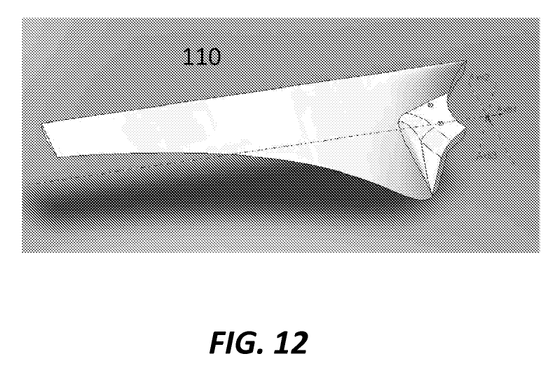

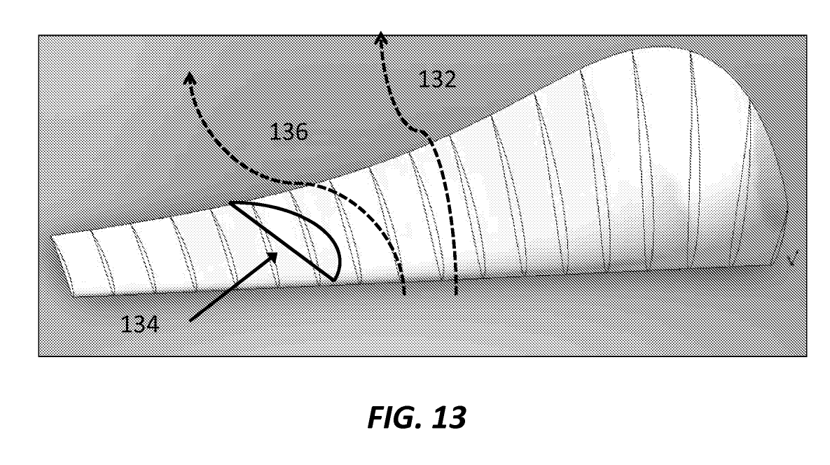

FIG. 11 shows high surface area lifting airfoils 110 with larger surface areas to extra power from diffuser 12. These blades 110 are pitched for increased airspeed from root to tip, and may be custom tapered for different lift area requirements, as illustrated in FIG. 12. FIG. 13 diagrams an operation flow cross section of the blades. The typical airflow on a wing 132 is perpendicular to the leading edge; the present disclosure teaches a rotated cross section 134 and aligned with radial flow 136 for increased performance.

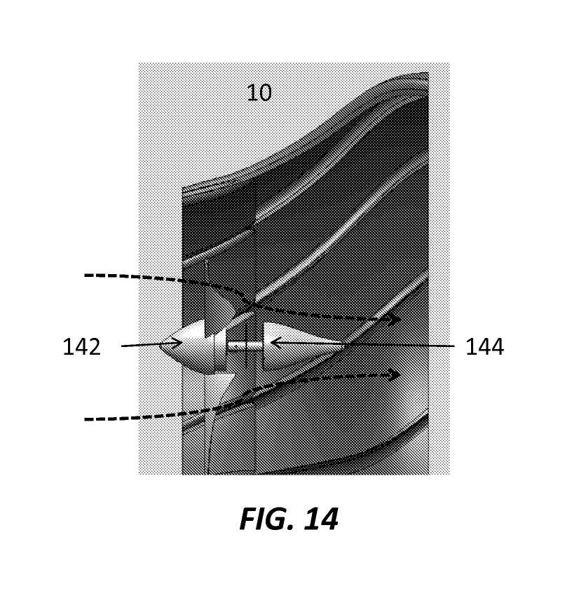

The low profile structure, almost teardrop shaped, of an exemplary diffuser augmented wind energy generation system 10 in FIG. 14 is designed to be more aerodynamic than conventional round structures. The swirled shapes of both nose cone spinner 142 and tail cone 144 prevent turbulence both before and after blades 14, resulting in low drag and increased efficiency of wind flow through the exemplary diffuser augmented wind energy generation system 10.

Further, the present disclosure may use a variety of materials. An exemplary material would be the use of light weight high volume fraction composites. These composites are comprised of several components, namely, a primary fiber component, a matrix resin, and any conventional fillers. Some exemplary fiber components that could be applicable to the present disclosure include, but is not limited to, glass, carbon, and aramid fibers. Some exemplary matrix resins that could be applicable to the present disclosure include, but is not limited to, epoxy or vinyl-esters, thermosets, and thermoplastics. The present disclosure enables the use of high glass content composites, leading to thinner components. More specifically, the present disclosure enables the use of composite materials as high as 75% fiber component by weight, with thicknesses as thin as 0.030 inches. This is a just exemplary embodiment; there may be other embodiments that achieve the same functions of providing a light weight, thin composite.

Yet another exemplary material may be the use of fiber optics or light emitting diodes molded into composites. Embedded fiber optics enables control of shroud color, built in lighting, or the transfer of data from electrical instrumentation, measuring various metrics including, but is not limited to, thermal, strain, and frequency readings. An exemplary application would be the use of the diffuser as a wind vane, temperature measurer, or any other application where the fiber optics may be used as electrical components of the entire system. This may also include LCD flexible components to allow active color control on a large surface area of the diffuser, enabling aesthetic changes, such as the blending of the diffuser into the sky background or the display of other variations of colors, patterns, images, or text.

Another exemplary material may be the use of translucent materials enabling control of aesthetics and temperature. Incorporating materials that are light in color reduces heat soaking. With the materials not absorbing as much heat in high temperature applications, the materials maintain stiffness and can avoid premature softening that is risky for structural integrity.

Yet another exemplary material may be the use of high modulus thin plastics, conventionally poly-ethylene or poly-propylene. This is effective for low cost and high volume manufacturing through rotational molding or injection processes. Additionally by incorporating fillers including, but is not limited to, nanocarbon pieces, silica, or any kind of clay, the present disclosure may increase the stiffness and elastic modulus of plastic, a traditionally soft material.

Yet another exemplary material may be the use of high volume UV curable resins, having similar mechanical properties as conventional composites. Composites can be made with different resins, many of them expensive by inherent nature of manufacturing. However, by using UV curable resins with cure speeds as low as 20 seconds, the present disclosure enables time savings during volume production manufacturing processes, leading to significant cost savings.

Yet another exemplary material may be the use of embedded lightning transfer meshes to protect from lightning strikes. The present disclosure teaches the incorporation of metal meshes into the diffuser composite itself, for example, by embedding pieces of copper or lightening transfer meshes to increase the longevity and survivability of the entire device. The metal acts to transfer lightning around the shroud to the metal tower and then to the ground.

Yet another exemplary material may be the use of self-healing composites that allow material integrity even after small cracks. These include fillers and healing capsules embedded within the composites that respond to cracks in the composites that occur during times of tremendous stress on the material, such as during strong storms. As cracks occur, the fillers rupture and expose a healing epoxy that leaks out and fills the crack, bonding the crack after stresses subside.

Yet another exemplary material may be the use of skeletal frames with flexible membranes that enable a flexible shroud. By using a trellis-type shroud that is comprised primarily of nano pieces, carbon fiber meshes with Dacron surfaces, or flexible silicone/natural rubbers, the present disclosure enables not just a stiffened shroud, but also whole surface flexibility. Additionally, the use of a porous shroud allows wind to flow through at a very small pore scale. Porosity changes along the entire diffuser may be controlled and changed to maximize performance of the present disclosure.

Yet another exemplary material may be the use of sound dampening or absorbing composites to control or eliminate emitted noises from the diffuser through the use of select material types, architecture, processes, assembly, and installation. Both material choices and physical shape can be designed and tailored for the selected frequency or acoustic absorptions to help birds and bats avoid impact. Shape modification of the diffuser, blades, shroud, and overall structure may be use to tune operation sounds at bird and bat avoidance frequencies.

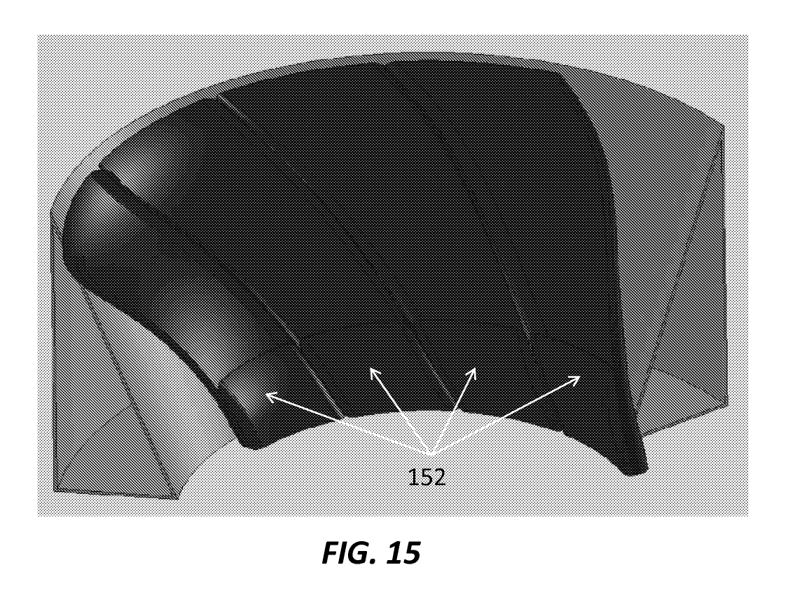

Additionally, the present disclosure teaches a high-speed, low-cost manufacturing method for the design and production of the presently disclosed wind energy generation system, as illustrated in FIG. 15. By manufacturing the shroud diffuser in cell sections 152, the cell sections 152 can be produced on an assembly line, and transported to any construction site to be assembled on-site by joining the cell sections 152 into subassemblies to make the full shroud diffuser. The use of structural tape or liquids to bond cell sections 152 together reduces weight over that of using traditional fasteners, and has the additional benefit of absorbing thermal expansion.

The foregoing description of the preferred embodiments is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

The present disclosure teaches a modular, multi-controller under central software control that requires only one inverter, one DC bus, and AC bus. By optimizing and integrating electrical priorities, the software is able to manage cost performance and requires very little hardware.

Additionally, the present disclosure a net metered wind farm concept that eliminates the need for a substation. A power distribution substation may be replaced by conventional smaller electrical service breaker boxes, about but not limited to 200/400 amps. Each service box may multiple turbines tied in to it and is net metered as one would do a home. Subsequently, each net metered station is linked together the same as a home development would, thus eliminating a large substation. Due to the small turbine power source as compared to the large turbines used in conventional windfarms, the power substation overhead may be distributed to all the mini net metered stations. Stations can mimic homes for net metering.

Within the wind farm concept, one 200 Amp service station may be a kiosk, with forty (40) 1 kW turbines at 5 amps each and one net meter per station. Stations may be tied into grid similar to a housing development. Lastly, the present disclosure teaches a linear series approach to using the net metered concept in a continuous array form that is useful in such locations as but not limited to trails, boardwalks, roads, perimeters, and beaches.

Another exemplary embodiment taught by the present disclosure is the use of diffusers made from solar panels. This enables attached solar panels to capture power from any angle. Battery storage cells may be co-located within the structure of the pole, shroud, blades, or structure, or they may be co-molded with them as to absorb the collective cost of each one.

Some more exemplary embodiments taught include the use of the present disclosure as elements of tower lighting and powers backup systems for lights. It may also serve as turbines on light posts to be net meters and grid separate light poles.

Lastly, the present disclosure teaches a portable system. This portability may be applicable in charging Systems, charge communications, phones, radios, lighting, water pumps and purifiers, antennaes, cellular towers or repeaters, broadband access points, meteorological towers as built in anemometers that always orient into the wind or as a built in weather vane. These applicable are all taught by the present disclosure by manufacturing a light weight, low-profile portable system.

The detailed description set forth below in connection with the appended drawings is intended as a description of exemplary embodiments in which the presently disclosed apparatus and system can be practiced. The term “exemplary” used throughout this description means “serving as an example, instance, or illustration,” and should not necessarily be construed as preferred or advantageous over other embodiments.

Further, although exemplary devices and schematics implement the elements of the disclosed subject matter have been provided, one skilled in the art, using this disclosure, could develop additional hardware and/or software to practice the disclosed subject matter and each is intended to be included herein.

In addition to the above described embodiments, those skilled in the art will appreciate that this disclosure has application in a variety of arts and situations and this disclosure is intended to include the same.

What is claimed is:

1. An diffuser-augmented wind turbine assembly for generating electricity, comprising:
a low-profile tower system coupled to a wind turbine, said wind turbine comprising:
a rifled diffuser shroud, said rifled diffuser shroud comprising light weight composites;
a hub rotatably mounted within said rifled diffuser shroud; and
a plurality of high surface area lifting airfoils coupled radially to said hub, and wherein said airfoils further comprise active control mechanisms; and
a bypass at a front entry plane of said rifled diffuser shroud for increased wind flow across said airfoils at low wind velocities.

2. The diffuser-augmented wind turbine assembly for generating electricity of claim 1, wherein said low-profile tower system further comprises a plenum chamber.

3. The diffuser-augmented wind turbine assembly for generating electricity of claim 1, wherein said rifled diffuser shroud further comprises solar panels.

4. The diffuser-augmented wind turbine assembly for generating electricity of claim 1, wherein said wind turbine is further comprised of an electrical bearing, said electrical bearing comprised of a slip ring and a friction bearing.

5. The diffuser-augmented wind turbine assembly for generating electricity of claim 1, wherein said rifled diffuser shroud is configured to have an angle gradient nearly parallel at a rifled diffuser shroud exit.

6. The diffuser-augmented wind turbine assembly for generating electricity of claim 1, wherein said assembly further comprises a multi-controller.

7. The energy diffuser-augmented wind turbine assembly for generating electricity of claim 6, wherein said multi-controller comprises central control software, an inverter, a DC us, and an AC bus.

8. A diffuser-augmented wind turbine, comprising:
a rifled diffuser shroud, said rifled diffuser shroud comprising light weight composites;
a hub rotatably mounted within said rifled diffuser shroud; and
a plurality of high surface area lifting airfoils coupled radially to said hub, and wherein said airfoils further comprise active control mechanisms.

9. The diffuser-augmented wind turbine of claim 8, wherein said hub comprises a nose cone spinner and a tail cone.

10. The diffuser-augmented wind turbine of claim 8, wherein said rifled diffuser shroud comprises individual panels, each panel comprising rifling and vertical stiffeners.

11. The diffuser-augmented wind turbine of claim 10, wherein said rifled diffuser shroud further comprises radial slots between said individual panels.

12. The diffuser-augmented wind turbine of claim 10, wherein said rifled diffuser shroud further comprises circumferential slots between said individual panels.

13. The diffuser-augmented wind turbine of claim 8, wherein said shroud is comprised porous material.

14. A method of generating electricity using a diffuser-augmented wind turbine assembly, comprising the steps of:
forming a rifled diffuser shroud from a light weight composite, rotatably mounting a hub within said rifled diffuser shroud, forming a plurality of high surface area lifting airfoils with active control mechanisms and radially coupling said plurality of high surface area lifting airfoils to said hub to form a wind turbine;
forming a low-profile tower system and coupling said low-profile tower system to said wind turbine; and
forming a bypass at a front entry plane of said rifled diffuser shroud, whereby electricity is generated at wind flow velocities that would not cause airfoil plane flow in non-bypass assemblies.

15. The method of generating electricity using said diffuser-augmented wind turbine assembly of claim 15, wherein said method of generating electricity further comprises the step of replacing a power distribution substation with by forming a net metered station with multiple diffuser-augmented wind turbine assemblies linked together.

16. The method of generating electricity using said diffuser-augmented wind turbine assembly of claim 16, wherein multiple net metered stations are linked together to eliminate a large substation.

17. The method of generating electricity using said diffuser-augmented wind turbine assembly of claim 16, wherein multiple net metered stations are arrayed in a linear fashion forming a continuous string of diffuser-augmented wind turbine assemblies.

18. The method of generating electricity using said diffuser-augmented wind turbine assembly of claim 15, wherein said step of forming a rifled diffuser shroud from a light weight composite comprises high volume UV curable resin manufacturing.

19. The method of generating electricity using said diffuser-augmented wind turbine assembly of claim 15, wherein said step of forming a rifled diffuser shroud from a light weight composite comprises embedding fiber optics within said light weight composite.

20. The method of generating electricity using a diffuser-augmented wind turbine assembly of claim 15, wherein said method further comprises forming a portable electricity generation system.
